(19) United States
(12) Patent Application Publication
(10) Pub. No.: US 2025/0217753 A1
(43) Pub. Date: Jul. 3, 2025

(54) LARGE LANGUAGE MODEL (LLM) BASED DATA PROCESSING IN PROCUREMENT AND SUPPLY CHAIN APPLICATIONS DEVELOPED BY CODELESS PLATFORM

(71) Applicant: NB Ventures, Inc. DBA GEP, Clark, NJ (US)

(72) Inventors: Subhash Makhija, Westfield, NJ (US); Saratendu Sethi, Apex, NC (US); Anil Kumar Goyal, Siliguri (IN); Shivendra Singh Malik, Vasco-da-Gama (IN)

(21) Appl. No.: 18/400,317

(22) Filed: Dec. 29, 2023

(51) Int. Cl. G06Q 10/08; G06F 8/34; G06F 40/40; G06Q 10/0631; G06Q 10/10; G06Q 30/04; H04L 51/02

(52) U.S. Cl. CPC G06Q 10/08; G06F 8/34; G06F 40/40; G06Q 10/06315; G06Q 10/103; G06Q 30/04; H04L 51/02

(57) ABSTRACT

The present invention provides a system and method for data processing in procurement and supply chain application developed by codeless platform. The invention includes one or more large language model (LLM) agents configured for processing one or more input received on an electronic user interface. The invention includes selecting a tool selection agent from a tool repository and invoking the selected tool by a tool execution agent for processing at least one task to be executed.

### BACKGROUND

### 1. Technical Field

The present invention relates generally to data processing. More particularly, the invention relates to large language models-based data processing in one or more enterprise application including procurement and supply chain applications developed by codeless platform.

### 2. Description of the Prior Art

Enterprise applications including procurement or supply chain applications have vast operational requirements for executing multiple tasks. However, due to the inherent nature of these operational requirement, real time modifications to the structure of the application itself is required for executing some of these tasks, which in turn impacts the nature of data generated through these enterprise applications. Since every organization has a different requirement, it is impractical to restructure enterprise application every time a new requirement is to be accommodated.

Even with codeless development of applications to overcome some of the above problems the architecture remains unsupportive in multiple aspects including working with different data abstraction. Further, enterprise applications developed though codeless platform, generate humongous amounts of data for processing in real time. To derive any learnings from such real time datasets is a tedious task considering the different verticals within an enterprise application such as supply chain application having sub applications like inventory management, contract management, invoice management etc. The learnings from each sub applications are distinct and for execution of a task requiring learnings from multiple such sub applications, the processing capabilities of the existing computing resources are limited. Moreover, even with Generative AI (Artificial intelligence) and large language models, the complexity of deriving meaningful insight from such distinct dataset for executing any task is extremely difficult.

Large language model as a machine learning model is trained on a large corpus of text data to generate outputs for various natural language processing (NLP) tasks, such as text generation, question answering, and machine translation. While Large language models are useful, the training of these models for a data flowing in an enterprise application built through a codeless platform is cumbersome. Considering the specific use cases prevalent in supply chain and procurement domain, the training of LLM on such dataset is very difficult. Moreover, the nature of data itself is varied and the limitation of existing LLM to process text data, makes it impossible to processing of data generated in the supply chain domain in other formats.

None of the prior arts address the processing complexity and technical limitations in executing functions associated with an enterprise application that are developed by codeless platform. Moreover, implementation of large language models for such enterprise applications developed by codeless platform are non-existent due the unknowns and the existing complexity in data processing for deriving meaningful insights to enable execution of the required enterprise application function. Furthermore, while scalability of the processing capability of existing computing resources while dealing with large language model is extremely challenging, such scaling in case of multiple large language models interacting to execute an enterprise function is even more cumbersome.

In view of the above problems, there is a need for a data processing system and method that can overcome the problems associated with the prior arts.

### SUMMARY

According to an embodiment, the present invention provides a system and method for large language model-based data processing in procurement and supply chain applications developed by codeless development platform. The data processing comprises receiving at least one input from a user on the electronic user interface; identifying one or more data objects from the received input to trigger a master controller LLM (large language model) agent for executing at least one task wherein the one or more data objects are associated with one or more application developed by a codeless platform; and triggering through a processor, one or more micro LLM agent by the master Controller LLM agent for selecting a tool from a tool repository by a tool selector agent wherein the tool repository includes one or more tools configured to execute the at least one task; and invoking the selected tool by a tool execution agent wherein the tool execution agent is configured to update the tool repository and act as a process orchestrator for executing the task.

The codeless platform includes a plurality of configurable components; a customization layer; an application layer; a shared framework layer; a foundation layer; a data layer; and a SCM application orchestrator, wherein the at least one processor is configured to cause the plurality of configurable components to interact with each other in a layered architecture to customize the one or more Supply Chain Management (SCM) application based on at least one operation to be executed using the customization layer, organize at least one application service of the one or more Supply Chain Management (SCM) application by causing the application layer to interact with the customization layer through one or more configurable components of the plurality of configurable components, wherein the application layer is configured to organize the at least one application service of the one or more Supply Chain Management (SCM) application; fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components; manage database native queries mapped to that at least one operation using a data layer to communicate with the foundation layer through one or more configurable components of the plurality of configurable components, wherein the data layer is configured to manage database native queries mapped to the at least one operation; and execute the at least one operation and develop the one or more Supply Chain Management (SCM) application using the SCM application orchestrator to enable interaction of the plurality of configurable components in the layered architecture.

In an embodiment, the one or more micro LLM agent and the Master controller LLM agent are finetuned by loading a plurality of historical dataset related to one or more application workflows of the codeless platform into a vector index. The vector index enables semantic search by the Master controller LLM agent. The method of finetuning includes triggering one or more unit of task action descriptions index and a knowledge graph on units of task as additional tools for the one or more micro LLM agent and the master controller LLM agent. Further the method includes generating variations of the input requiring cross-referencing the unit of task action descriptions and knowledge graph including substituting steps within the workflow or augmenting the input with additional flows. The method also includes running the input including the variations through a reference LLM, identifying one or more high reward input-output pair for fine tuning master controller LLM and one or more micro LLM agent, and evaluating on a testing dataset, contextualization and substitution ability of the one or more agent through the description index wherein a matrix is utilized on the testing dataset to assess the agents ability.

In an embodiment, the present invention provides a large language model (LLM) based data processing method. The method includes receiving at least one input from a user on the electronic user interface, identifying one or more data objects from the received input to trigger a micro LLM (large language model) agent for executing at least one task wherein an intent of the user is determined based on the identified data objects by a bot configured to map the intent with the micro LLM agent, selecting a tool from a tool repository by a tool selector agent wherein the tool repository includes one or more tools configured to execute the at least one task; and invoking the selected tool by a tool execution agent wherein the tool execution agent is configured to update the tool repository and act as a process orchestrator for executing the task.

In an advantageous aspect, the codeless development platform architecture is a layered architecture structured to execute a plurality of complex SCM enterprise application operations in an organized and less time-consuming manner due to faster processing as the underlining architecture is appropriately defined to execute the operations through shortest path. Further, the platform architecture enables secured data flow through applications and resolution of code break issues without affecting neighboring functions or application. Moreover, the large language model's (LLM) accuracy of processing any input to execute a SCM task is dependent on the efficiency of processing real time datasets generated due to the codeless platform architecture. The Master controller LLM agent and the micro LLM agent are configured to process inputs by considering the real time datasets generated in the one or more SCM application developed by codeless platform. The technical problem in accommodating the learnings from a real time dataset is possible due to the Master controller LLM agent and Micro LLM agent based data processing.

In another advantageous aspect, the present invention utilizes Machine Learning algorithms, large language models, artificial intelligence-based process orchestration for data processing to execute one or more SCM application operations.

### BRIEF DESCRIPTION OF THE DRAWINGS

The disclosure will be better understood and when consideration is given to the drawings and the detailed description which follows. Such description makes reference to the annexed drawings wherein:

FIG. 1 is an architecture diagram of a large language model-based data processing system configured for executing one or more tasks associated with one or more enterprise applications developed by a codeless platform in accordance with an embodiment of the invention.

FIG. 2 a flow diagram of a large language model (LLM) based data processing method is provided in accordance with an embodiment of the invention.

FIG. 3 is a block diagram depicting one or more micro LLM agent of the data processing system in accordance with an embodiment of the invention.

FIG. 4 is a block diagram depicting a master controller LLM agent and one or more micro LLM agent of the data processing system in accordance with an embodiment of the invention.

FIG. 5 shows two user input configurations received by the data processing system in accordance with an example embodiment of the invention.

FIG. 6 shows deep learning based large language model architecture with encoder and decoder in accordance with an example embodiment of the invention.

FIG. 6A shows neural network of the data processing system in accordance with an example embodiment of the invention.

FIG. 7 is a flow diagram depicting creation of a contract entity collector tool as a supply chain management task in accordance with an example embodiment of the invention.

FIG. 7A is a flow diagram depicting contract creation tool as a supply chain management task in accordance with an example embodiment of the invention.

FIG. 8 shows a system prompt input of the data processing system in accordance with an example embodiment of the invention.

FIG. 8A shows user input with a natural language command of the data processing system in accordance with an example embodiment of the invention.

FIG. 8B shows a response of the data processing system to the user input in accordance with an embodiment of the invention.

FIG. 8C shows a training data format of the data processing system in accordance with an example embodiment of the invention.

FIG. 9 shows an electronic user interface of the data processing system having a chatbot for conversation orchestration to execute contract creation task in accordance with an example embodiment of the invention.

FIG. 10 shows a table of foundational units of work (micro LLM agents) available in the codeless platform that are used across various applications being built on the platform in accordance with an embodiment of the invention.

FIG. 11 shows a table of how the data processing system creates a Source to Pay application by assembling units of work of Codeless platform in accordance with an example embodiment of the invention.

FIG. 12 shows a table of how the data processing system creates a Supply Chain application by assembling the units of work of Codeless platform in accordance with an example embodiment of the invention.

FIG. 13 shows a table of how a Master Controller LLM agent synthesizes three new custom applications based on its training of all existing workflows of the one or more applications created on the codeless platform in accordance with an example embodiment of the invention.

### DETAILED DESCRIPTION

Described herein are the various embodiments of the present invention, which includes large language model-based data processing system and method in procurement and supply chain application developed on a codeless platform.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “master controller LLM agent,” “micro LLM agent”, or “Large graph model (LGM),” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to a large language model-based data processing system and method of procurement and supply chain application developed by codeless platform.

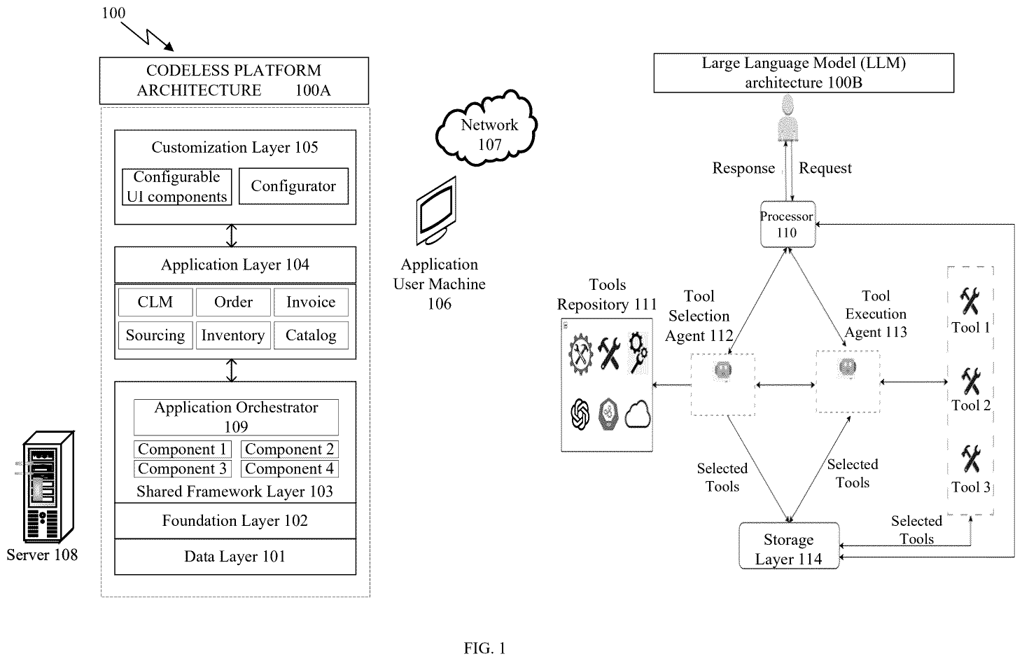

Referring to FIG. 1, an architecture diagram of a large language model-based data processing system 100 in a procurement and supply chain application developed by a codeless platform is provided in accordance with an embodiment of the present invention. The architecture of the data processing system includes a codeless platform architecture 100A and a large language model architecture 100B.

The codeless platform architecture 100A of the system 100 is a layered architecture 100A configured to process complex operations of one or more applications including supply chain management (SCM) applications using configurable components of each layer of the architecture 100A. The layered architecture enables faster processing of complex operations as the workflow may be reorganized dynamically using the configurable components. The layered architecture includes a data layer 101, a foundation layer 102, a shared framework layer 103, an application layer 104 and a customization layer 105. Each layer of the codeless platform architecture 100A includes a plurality of configurable components interacting with each other to execute at least one operation of the SCM enterprise application. It shall be apparent to a person skilled in the art that while FIG. 1 provide essential configurable components, the nature of the components itself enables redesigning of the platform architecture through addition, deletion, modification of the configurable components and their positioning in the layered architecture. Such addition, modification of configurable components depending on the nature of the architecture layer function shall be within the scope of this invention.

In an exemplary embodiment, the configurable components enable an application developer user/citizen developer, a platform developer user and a SCM application user working with the SCM application to execute the operations to code the elements of the SCM application through configurable components. The SCM application user or end user triggers and interacts with the customization layer 105 for execution of the operation through application user machine 106, a function developer user or citizen developer user triggers and interacts with the application layer 104 to develop the SCM application for execution of the operation through citizen developer machine, and a platform developer user through its computing device triggers the shared framework layer 103, the foundation layer 102 and the data layer 101 to structure the platform for enabling codeless development of SCM applications.

In an embodiment the present invention provides one or more SCM enterprise application with an end user application UI and a citizen developer user application UI for structuring the interface to carry out the required operations. Further, the layered platform architecture reduces complexity as the layers are built one upon another thereby providing high levels of abstraction, making it extremely easy to build complex features for the SCM application. However, one or more applications developed through the platform architecture requires reconfiguration of task management in the application. Since the functions are added or removed or modified by the developer seamlessly, the reconfiguration of the system to manage the related changes in the task is cumbersome.

In one embodiment, the codeless platform architecture 100A provides the cloud agnostic data layer 101 as a bottom layer of the architecture. This layer provides a set of micro-services that collectively enable discovery, lookup and matching of storage capabilities to needs for execution of operational requirement. The layer enables routing of requests to the appropriate storage adaptation, translation of any requests to a format understandable to the underlying storage engine (relational, key-value, document, graph, etc.). Further, the layer manages connection pooling and communication with the underlying storage provider and automatically scales and de-scaling the underlying storage infrastructure to support operational growth demands.

In an example embodiment, a document data stores data abstraction of the data layer store all attributes of a document as a single record, much like a relational database system. The data is usually denormalized in these document stores, making data joins common in traditional relational systems unnecessary. Data joins (or even complex queries) can be expensive with this data store, as they typically require map/reduce operations which don't lend themselves well in transactional systems (OLTP-online transactional processing).

In another example embodiment, a relational data abstraction of the data layer allows for data to be sliced and analyzed in an extremely flexible manner.

In a related embodiment, the plurality of configurable components includes one or more data layer configurable components including but not limited to Query builder, graph database parser, data service connector, transaction handler, document structure parser, event store parser and tenant access manager. The data layer provides abstracted layers to the SCM service to perform data operations like Query, insert, update, delete and Join on various types of data stores document database (DB) structure, relational structure, key value structure and hierarchical structure.

In an embodiment the platform architecture provides the foundation layer 102 on top of the data layer 101 of the architecture 100. This layer provides a set of microservices that execute the tasks of managing code deployment, supporting code versioning, deployment (gradual roll out of new code) etc. The layer collectively enables creation and management of smart forms (and templates), framework to define UI screens, controls etc. through use of templates. Seamless theming support is built to enable specific form instances (created at runtime) to have personalized themes, extensive customization of the user experience (UX) for each client entity and or document. The layer enables creation, storage and management of code plug-ins (along with versioning support). The layer includes microservice and libraries that enable traffic management of transactional document data (by client entity, by document, by template, etc.) to the data layer 101, enables logging and deep call-trace instrumentation, support for request throttling, circuit breaker retry support and similar functions. Another set of microservice enables service to service API authentication support, so API calls are always secured. The foundation layer micro services enable provisioning (on boarding new client entity and documents), deployment and scaling of necessary infrastructure to support multi-tenant use of the platform. The set of microservices of foundation layer are the only way any higher layer microservice can talk to the data layer microservices. Further, machine learning techniques auto-scale the platforms to optimize costs and recommend deployment options for entity such as switching to other cloud vendors etc.

In an exemplary embodiment, the data layer 101 and foundation layer 102 of the architecture 100 function independent of the knowledge of the operation. Since, the platform architecture builds certain configurable component as independent of the operation in the application, they are easily modifiable and restructured.

In a related embodiment, the plurality of configurable components includes one or more foundation layer configurable components including but not limited to logger, Exception Manager, Configurator Caching, Communication Layer, Event Broker, Infra configuration, Email Sender, SMS Notification, Push notification, Authentication component, Office document Manager, Image Processing Manager, PDF Processing Manager, UI Routing, UI Channel Service, UI Plugin injector, Timer Service, Event handler, and Compare service for managing infrastructure and libraries to connect with cloud computing service.

In an embodiment, the platform architecture provides the shared framework layer 103 on top of the foundation layer 102. This layer provides a set of microservices that collectively enable authentication (identity verification) and authorization (permissioning) services. The layer supports cross-document and common functions such as rule engine, workflow management, document approval (built likely on top of the workflow management service), queue management, notification management, one-to-many and many-to-one cross-document creation/management, etc. The layer enables creation and management of schemas (aka documents), and support orchestration services to provide distributed transaction management (across documents). The service orchestration understands different document types, hierarchy and chaining of the documents etc.

The shared framework layer 103 has the notion of our operational or application domains, the set of microservices that contribute this layer hosts all the common functionality so individual documents (implemented at the application layer 104) do not have to repeatedly to the same work. In addition to avoiding the reinventing the wheel separately by each developer team, this layer of microservices standardizes the capabilities so there is no loss of features at the document level, be it adding an attribute (that applies to a set of documents), supporting complex approval workflows, etc. The rule engine along with tools to manage rules is part of this layer.

In a related embodiment, the plurality of configurable components includes one or more shared framework configurable components including but not limited to license manager, Esign service, application marketplace service, Item Master Data Component, organization and accounting structure data component, master data, Import and Export component, Tree Component, Rule Engine, Workflow Engine, Expression Engine, Notification, Scheduler, Event Manager, and version service.

In one embodiment, the architecture 100 provides the application layer 104 on top of the shared framework layer 103 of the architecture. The developer user of the platform will interact with the application layer 103 for structuring the SCM application. This is also the first layer, that defines SCM specific documents such as requisitions, contracts, orders, invoices etc. This layer provides a set of microservices to support creation of documents (requisition, order, invoice, etc.), support the interaction of the documents with other documents (ex: invoice matching, budget amortization, etc.) and provide differentiated operational/functional value for the documents in comparison to a competition by using artificial intelligence and machine learning. This layer also enables execution of complex operational/functional use cases involving the documents.

In an exemplary embodiment, a developer user or admin user will structure one or more SCM application and associated functionality by the application layer of microservices, either by leveraging the shared frameworks platform layer or through code to enable the notion of specific documents or through building complex functionality by intermingling shared frameworks platform capabilities with custom code. Besides passing on the entity metadata to the shared frameworks layer, this set of microservices do not carry any concern about where or how data is stored. Data modeling is done through template definitions and API calls to the shared frameworks platform layer. This enables this layer to primarily and solely focus on adding operational/functional value without worrying about infrastructure.

Further, in an advantageous aspect, all functionality or application services built at the application layer are exposed through an object model, so higher levels of application orchestrations of all these functionalities is possible to build by custom implementations for end users. The platform will stay pristine and clean and be generic, while at the same time, enables truly custom features to be built in a lightweight and agile manner. The system of the invention is configured to adapt to the changes in the application due to the custom features and operate the application to manage one or more tasks to be executed.

In an embodiment, the architecture 100 provides the customization layer 105 as the topmost layer of the architecture above the application layer 104. This layer provides microservices enabling end users to write codes to customize the operational flows as well as the end user application UI to execute the operations of SCM. The end user can orchestrate the objects exposed by the application layer 104 to build custom functionality, to enable nuanced and complex workflows that are specific to the end user operational requirement or a third-party implementation user.

In a related embodiment, the plurality of configurable components includes one or more customization layer configurable components including but not limited to a plurality of rule engine components, configurable logic component, component for structuring SCM application UI, Layout Manager, Form Generator, Expression Builder Component, Field & Metadata Manager, store-manager, Internationalization Component, Theme Selector Component, Notification Component, Workflow Configurator, Custom Field Component & Manager, Dashboard Manager, Code Generator and Extender, Notification, Scheduler, form Template manager, State and Action configurator for structuring the one or more SCM application to execute at least one SCM application operation.

In an exemplary embodiment, each of these layers of the platform architecture communicates or interacts only to the layer directly below and never bypasses the layers through operational workflow thereby enabling highly productive execution with secured interaction through the architecture.

Depending on the type of user the user interface (UI) of the application user machine 106 is structured by the platform architecture. The application user machine 106 with a application user UI is configured for sending, receiving, modifying or triggering processes and data object for operating one or more of a SCM application over a network 107.

The computing devices referred to as the entity machine, server, processor etc. of the present invention are intended to represent various forms of digital computers, such as laptops, desktops, workstations, personal digital assistants, and other appropriate computers. Computing device of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

The system includes a server 108 configured to receive data and instructions from the application user machines 106. The system 100 includes a support mechanism for performing various prediction through AI engine and mitigation processes with multiple functions including historical dataset extraction, classification of historical datasets, artificial intelligence based processing of new datasets and structuring of data attributes for analysis of data, creation of one or more data models configured to process different parameters.

In an embodiment, the system is provided in a cloud or cloud-based computing environment. The codeless development system enables more secured processes.

In an embodiment the server 108 of the invention may include various sub-servers for communicating and processing data across the network. The sub-servers include but are not limited to content management server, application server, directory server, database server, mobile information server and real-time communication server.

In example embodiment the server 108 shall include electronic circuitry for enabling execution of various steps by server processor. The electronic circuitry has various elements including but not limited to a plurality of arithmetic logic units (ALU) and floating-point Units (FPU's). The ALU enables processing of binary integers to assist in formation of at least one table of data attributes where the data models implemented for dataset characteristic prediction are applied to the data table for obtaining prediction data and recommending action for codeless development of SCM applications. In an example embodiment the server electronic circuitry includes at least one Athematic logic unit (ALU), floating point units (FPU), other processors, memory, storage devices, high-speed interfaces connected through buses for connecting to memory and high-speed expansion ports, and a low speed interface connecting to low speed bus and storage device. Each of the components of the electronic circuitry, are interconnected using various busses, and may be mounted on a common motherboard or in other manners as appropriate. The processor can process instructions for execution within the server 108, including instructions stored in the memory or on the storage devices to display graphical information for a graphical user interface (GUI) on an external input/output device, such as display coupled to high speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

In an example embodiment, the system of the present invention includes a front-end web server communicatively coupled to at least one database server, where the front-end web server is configured to process the dataset characteristic data based on one or more data models and applying an AI based dynamic processing logic to automate prioritization of task in the application developed by the codeless development actions through process orchestrator.

In an embodiment, the platform architecture 100 of the invention includes an application orchestrator 109 configured for enabling interaction of the plurality of configurable components in the layered architecture 100 for executing at least one SCM application operation and development of the one or more SCM application. The application orchestrator 109 includes plurality of components including an application programming interface (API) for providing access to configuration and workflow operations of SCM application operations, an Orchestrator manager configured for Orchestration and control of SCM application operations, an orchestrator UI/cockpit for monitoring and providing visibility across transactions in SCM operations and an AI based application orchestration engine configured for interacting with a plurality of configurable components in the platform architecture for executing SCM operations.

In an embodiment, the application orchestrator includes a blockchain connector for integrating blockchain services with the one or more SCM application and interaction with one or more configurable components. Further, Configurator User interface (UI) services are used to include third party networks managed by domain providers.

In a related aspect, the Artificial intelligence (AI) based orchestrator engine enables execution of SCM operation by at least one data model wherein the AI engine transfers processed data to the UI for visibility, exposes SCM operations through API and assist the manager for application orchestration and control.

In an exemplary embodiment, the AI engine employs machine learning techniques that learn patterns and generate insights from the data for enabling the process orchestrator to automate operations. Further, the AI engine with ML employs deep learning that utilizes artificial neural networks to mimic biological neural network in human brains. The artificial neural networks analyze data to determine associations and provide meaning to unidentified or new dataset.

In another embodiment, the invention enables integration of Application Programming Interfaces (APIs) for plugging aspects of AI into the dataset characteristic prediction and operations execution for operating one or more SCM enterprise application.

In an embodiment, the system 100 of the present invention includes a workflow engine that enables monitoring of workflow across the SCM applications. The workflow engine with the application orchestrator enables the platform architecture to create multiple approval workflows. The task assigned to a user is prioritized through the AI based data processing system based on real time information.

In an embodiment the machine 106 may communicate with the server 108 wirelessly through communication interface, which may include digital signal processing circuitry. Also, the machine (106) may be implemented in a number of different forms, for example, as a smartphone, computer, personal digital assistant, or other similar devices.

In an embodiment, the large language model architecture 110B includes a processor 111 configured for receiving the input from a user through the electronic user interface and generating a response on an electronic user interface. The processor serves as the bridge between the user and the backend components of the LLM architecture. The LLM architecture 100B includes a tools repository 111 configured for storing one or more tools like multiple custom, curated and domain specific tools wherein each tool is built with a specific task or functionality to execute. The tools could be python functions, agents, API (application programming Interface) calls among others.

The processor 111 may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user/demand planner and convert them for submission to the processor. In addition, an external interface may be provided in communication with processor, so as to enable near area communication of device with other devices. External interface may provide, for example, for wired communication in some implementations, or for wireless communication in other implementations, and multiple interfaces may also be used.

In a related embodiment, the LLM architecture 100B includes a tool selector agent 112 which is a custom fine-tuned agent configured for selecting and changing a required set of tool to execute a user specific task. This agent 112 is supported by a finetuned LLM calibrated for tool selections and function execution tasks.

In another related embodiment, the LLM architecture 110B includes tool execution agent 113 configured to access the tools selected by the tool selection agent 112. The tool execution agent 113 is configured to invoke the tools selected by the tool selection agent 112 and also in an order as recommended by the tool selection agent 112. Further the tool execution agent 113 is configured to determine if the tool response is supposed to be passed to the user i.e it acts as a conversation or process orchestrator. The tool execution agent 113 interacts with the tool selection agent 112 to update the set of selected tools in scenarios where the tool execution fails. It passes the error messages to the tool selection agent 112 to decide if a new tool is to be added or an existing tool is to be removed from the tool chain.

In an exemplary embodiment, the tool execution agent is an agent that receives the tools selected by the selector and orchestrates their execution. The tool execution agent is configured for tool execution i.e Calling the tools identified by the tool selecting agent in the sequence requested. It passes inputs in the required formats by the tools. The tool execution agent performs execution state control as it receives the response from the tools and checks if the tool execution is complete or is an intermediate response from the tool. Further, the tool execution agent is configured for conversation state management by keeping track of the conversation state, outputs received from the previous tools.

In an example embodiment, the tools include interface library-based functions configured to execute a deterministic flow of logic. For eg: Python functions could wrap multiple utilities in them such as ML model and LLM executors etc. The tools also include application programming interface (API) executors that executes API calls when requested. The system includes a set of API executors of all major API's form part of the toolbox. Further, the tools also include databases and data source connector tools. The tool includes large language model (LLM) with access to a bundle of tools to achieve pre-defined objectives. These agents are driven by prompt(s) configured to enable process orchestration and tool selection.

In yet another embodiment, the LLM architecture 110B includes a storage layer 114 configured to keep track of all the required data or information generated during data processing. This component of the LLM architecture 110B is configured for storing information such as memory objects, the selected tools, the state of execution and the error messages among others.

In an exemplary embodiment the processor 110 is a request processor configured to route user input to the LLM architecture components including the tool selection agent 112, the tool execution agent 113, and the storage layer 114.

In an exemplary embodiment, the memory or storage layer may be a volatile, a non-volatile memory or memory may also be another form of computer-readable medium, such as a magnetic or optical disk. The memory store may also include storage device capable of providing mass storage. In one implementation, the storage device may be or contain a computer-readable medium, such as a floppy disk device, a hard disk device, an optical disk device, or a tape device, a flash memory or other similar solid-state memory device, or an array of devices, including devices in a storage area network or other configurations.

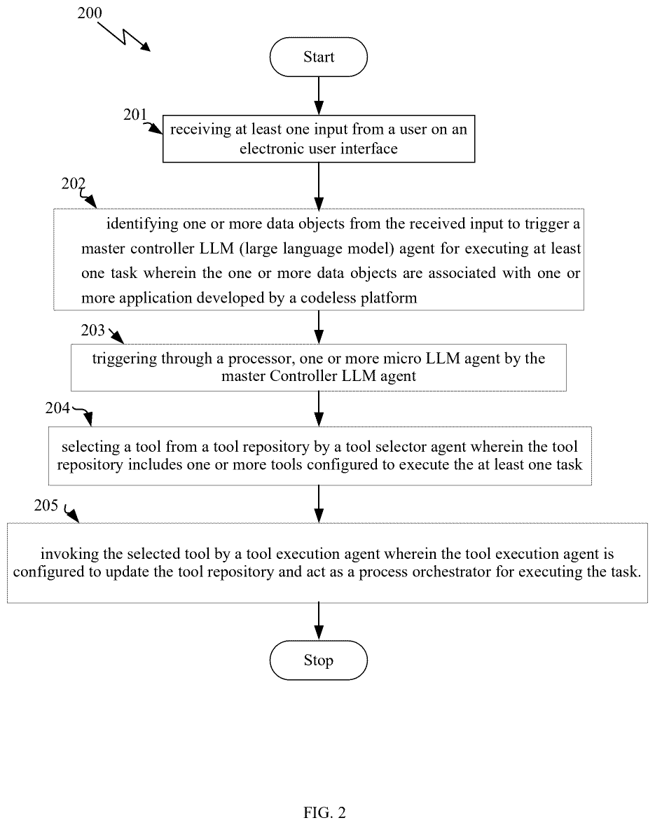

Referring to FIG. 2, a flow diagram 200 of a large language model (LLM) based data processing method is provided in accordance with an embodiment of the invention. The method 200 includes the step 201 of receiving at least one input from a user on an electronic user interface. In step 202 identifying one or more data objects from the received input to trigger a master controller LLM (large language model) agent for executing at least one task wherein the one or more data objects are associated with one or more application developed by a codeless platform. In step 203 triggering through a processor, one or more micro LLM agent by the master Controller LLM agent. In step 204 selecting a tool from a tool repository by a tool selector agent wherein the tool repository includes one or more tools configured to execute the at least one task and in step 205 invoking the selected tool by a tool execution agent wherein the tool execution agent is configured to update the tool repository and act as a process orchestrator for executing the task.

Referring to FIG. 3, a block diagram 300 depicting one or more micro LLM (large language model) agent of the data processing system is provided in accordance with an embodiment of the invention. The micro LLM agents include large language models (LLM), storage layer if necessary, and one or more tools. Once the input is received by the data processing system, a task specific prompt is generated to trigger one or more micro LLM agents. Each of the one or more micro LLM agents is trained on a historical dataset associated with at least one application of the one or more application developed by the codeless platform. Depending on the task to be executed, the system identifies and triggers the required tool for execution of the task.

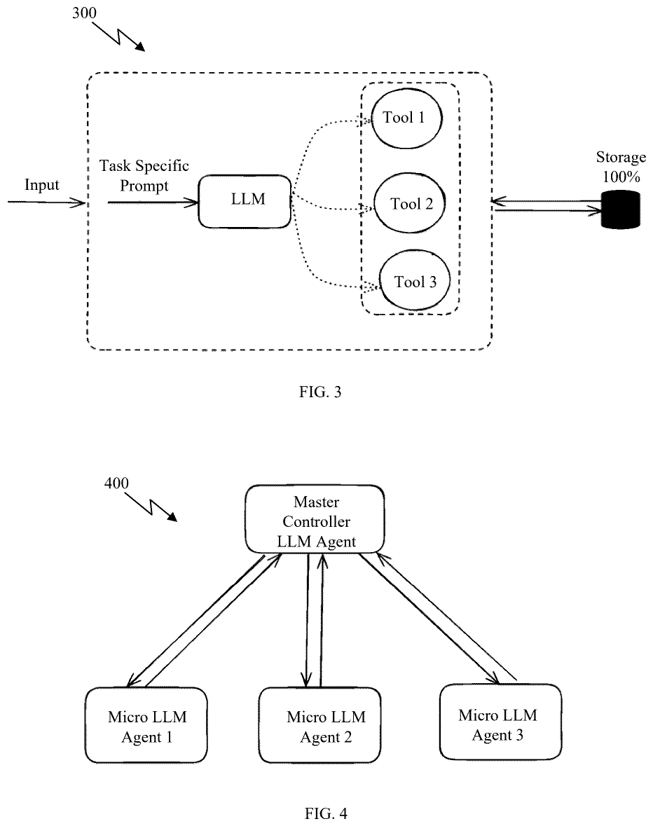

FIG. 4 is a block diagram 400 depicting a master controller LLM agent and one or more micro LLM agent of the data processing system in accordance with an embodiment of the invention. The master controller LLM agent is configured for identifying one or more micro LLM agents based on the intent of the user for executing a task. Since, the task is associated with a supply chain or procurement application, the identification of the intent associated with the application is critical and the Master Controller LLM agents which is trained with all sub-application datasets is configured to derive the relationship between multiple sub applications to trigger the relevant micro LLM agent.

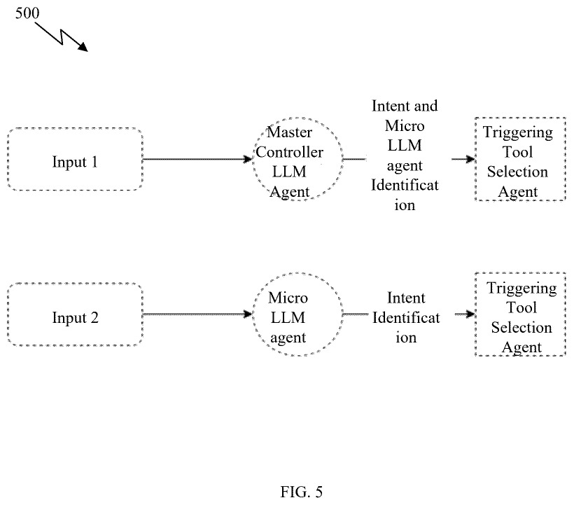

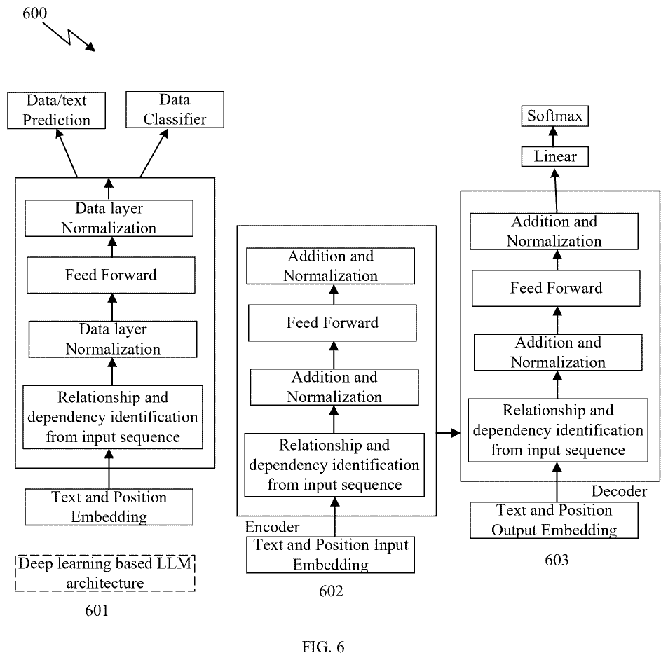

In an exemplary embodiment the data processing method of the invention includes two processing configurations as depicted in the flow diagram 500 of FIG. 5. The data processing method includes a Master Controller LLM agent driven identification of intent and identification of micro LLM agent. Also, the data processing method includes a micro LLM agent driven intent identification from the received input.

In another exemplary embodiment, the data processing system and method of the invention includes an identification bot configured to determine the LLM agent (Master controller LLM agent) or (Micro LLM agent) for executing the task.

In an embodiment, the at least one application includes a supply chain management application and the at least one task includes a supply chain management application task such as contract management, Purchase order, invoice management, Spend analysis, Sourcing, inventory management, demand planning, quality management, supply planning, should cost modeling, transportation management, warehouse management, forecasting, vendor management, risk assessment management and project management.

In an embodiment, the tool selection agent is a micro LLM agent configured to select and chain tools that can execute the tasks.

In an embodiment, the process orchestrator performs sequence management, execution state control and conversation state management.

In an embodiment, the master controller LLM agent is configured to adapt to real time changing characteristics of the one or more application developed by the codeless platform and interact with the one or more micro LLM agents to execute the at least one task.

In an exemplary embodiment, the method of training one or more micro LLM agent and the master controller LLM agent includes the step of collecting, storing and pre-processing a plurality of historical data as a training data wherein the historical data is stored in a SCM historical database. The training includes the step of cleansing the training dataset by converting the historical data, removing unwanted text from the historical data and tokenizing the training dataset into sequences of tokens that form the training dataset. Further, the training method includes configuring a neural network based on the training dataset wherein the micro LLM agent is trained with supervised and unsupervised learning by presenting a sequence of text to the LLM agent for training the agent to predict next text in the sequence wherein the LLM agent adjusts its weight based on a difference between its prediction and actual text.

In a related embodiment, the method of training includes evaluating performance of the one or more micro LLM agent based on a testing dataset wherein the one or more micro LLM agent is finetuned by adjusting one or more hyperparameters, chaining model architecture or training the micro LLM agent on additional training dataset to improve performance.

In an exemplary embodiment, a method of fine tuning the one or more micro LLM agent and the Master controller LLM agent includes the step of loading a plurality of historical dataset related to one or more application workflows of the codeless platform into a vector index to enable semantic search. The finetuning method includes the step of triggering one or more unit of task action descriptions index and a knowledge graph on units of task as additional tools for the one or more micro LLM agent and the master controller LLM agent. The finetuning method includes generating variations of the input requiring cross-referencing the unit of task action descriptions and knowledge graph including substituting steps within the workflow or augmenting the input with additional flows. The finetuning further includes running the input including the variations through a reference LLM, identifying one or more high reward input-output pair for fine tuning master controller LLM and one or more micro LLM agent, and evaluating on a testing dataset, contextualization and substitution ability of the one or more LLM agents through the description index wherein a matrix is utilized on the testing dataset to assess the one or more LLM agents.

In an embodiment, the micro LLM agent is configured to be trained in a distributed structure with artificial intelligence controllers wherein different parts of the micro LLM agent are distributed across a plurality of Graphics processing units (GPU) for parallel training of the micro LLM agent. The GPUs (Graphical processing units) with Master controller LLM agents enable enhancement of computing power by processing humongous amount of data.

In a related embodiment, the parallel training of the micro LLM agent includes data parallelism, sequence parallelism, pipeline parallelism and tensor parallelism.

In an embodiment, the master controller LLM agent is trained on one or more workflows of the one or more SCM application developed by the codeless platform wherein the master controller LLM agent is configured to generate codes for supplementing operations executed by the one or more SCM application.

In an embodiment, the electronic user interface includes an input component configured to receive the input, wherein the input component is a chatbot configured to receive a text, image or voice input wherein the image or voice input is converted to text by one or more processors for enabling the master controller LLM agent to identify the intent of the user and the at least one task to be executed.

In an exemplary embodiment, the data processing system of the invention includes a data network configured for storing and processing of one or more supply chain application dataset of the one or more supply chain application developed by the codeless platform, wherein a data network server is configured to receive the one or more supply chain application dataset from at least one data source. The data network includes one or more data element nodes configured to create one or more sub-network through a graphical data structure wherein one or more data elements are extracted from the one or more supply chain application dataset for analysis to identify the one or more data elements to be ingested as one or more data element node of the data network. The data network further includes one or more data connectors of the graphical data structure configured for connecting the one or more data element node to form the data network wherein the one or more data connectors include at least one identifier configured to identify the one or more data element node of the data network based on at least one relationship between one or more data attributes associated with the received input, the at least one data object and one or more supply chain application dataset. The data processing system includes an AI engine coupled to the processor configured for processing the input including the one or more data objects based on ensemble of one or more micro LLM agent wherein the one or more data attribute of the one or more supply chain application dataset are linked and the identifier is assigned based on the at least one relationship to one or more processed data elements of the one or more supply chain application dataset associated with the data attribute before ingesting the data element in the data network as a data element node to create the data network.

In an embodiment, the data processing system of the invention includes one or more large graph models (LGM) configured to interact with the one or more Micro LLM agent and Master controller LLM agent based on alignment of representation basis of graphs and text through paired data enabling interaction through natural language, or by transforming graph structures to text representations including adjacent list, edge list and inserting into LLM agents as prompts, or by aligning behavior of one or more graph models with one or more graph task scripts.

As the complexity of graph increases, the pre-training of large graph models (LGM) becomes more evident. Unlike pre-training methods for other types of data, such as languages and images, which focus primarily on semantic information, graphs contain rich structural information. Pre-training large graph models essentially needs to integrate structural and semantic information from diverse graph datasets. Pre-training on a wide range of graph datasets and tasks act as a regularizing mechanism, preventing the model from overfitting to a specific task and improving generalization performance. Further, by pre-training large graph models on diverse graph datasets, they are configured to capture a wide range of structural patterns, which are applied, adapted, or fine-tuned to graph data in similar domains, maximizing the model's utility.

Further, LLM and LGM required post processing to enhance their ability to downstream tasks. Some of the post-processing techniques include prompting, parameter-efficient fine-tuning, reinforcement learning with feedback, and model compression.

In an exemplary embodiment, the data network structured on relationships between documents or references to documents maintains the relationship across documents and navigates across documents in a blazingly fast manner. Nodes in the graph can be partitioned easily, making it conductive to building horizontally scalable systems, which in turn enables building of LGM models.

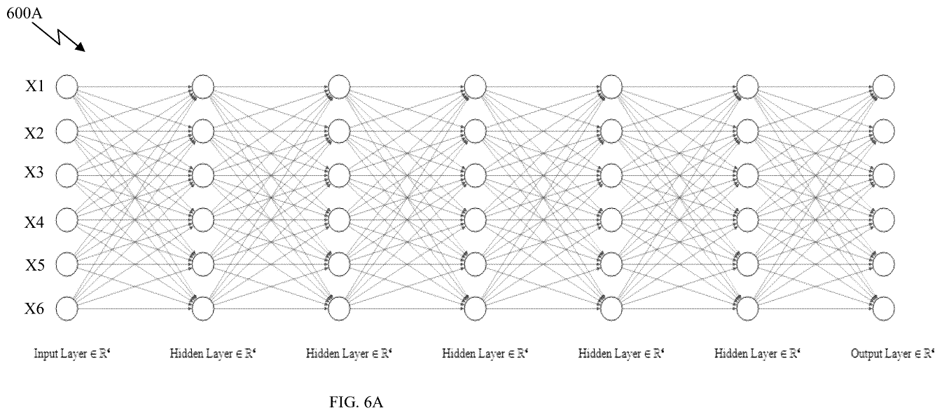

In an exemplary embodiment, the data processing system of the invention is configured for large-scale pre-training of models on supply chain and procurement domain data and adaptation to particular SCM tasks or sub domains. However, as larger models are pre-trained, full fine-tuning, which retrains all model parameters, becomes less feasible. In an advantageous aspect, Low-Rank Adaptation (LORA), is used which freezes the pre-trained model weights and injects trainable rank decomposition matrices into each layer of the deep learning based LLM architecture 600 as shown in FIG. 6. This greatly reduces the number of trainable parameters for downstream tasks. LORA significantly reduces the number of trainable parameters and the GPU memory requirements. LORA performs better despite having fewer trainable parameters, a higher training throughput, and, unlike adapters, no additional inference latency. Further, the data processing system facilitates integration of LORA with other models to provide efficient implementations and model checkpoints.

Referring to FIG. 6, a flow diagram 600 depicting a deep learning based large language model architecture 601 with encoder 602 and decoder 603 is provided in accordance with an example embodiment of the invention. To process a text input with a deep learning LLM model, it is tokenized into a sequence of words. These tokens are then encoded as numbers and converted into embeddings, which are vector-space representations of the tokens that preserve their meaning. Next, the encoder in architecture transforms the embeddings of all the tokens into a context vector. The context vector allows the model to attend to different parts of an input sequence to capture its relationships and dependencies. Using the context vector, the architecture decoder generates output based on data objects of the input. For instance, the data object of the input provided by the user acts as an intent identifier and lets the decoder produce the subsequent word that naturally follows. Then, the data processing system reuses the same decoder, but at this instance the intent identifier is the previously produced next word. This process is repeated to create an entire paragraph, starting from a leading sentence. The context vector is large so it can handle very complex concepts, and with many layers in its encoder and decoder. The LLM based on deep learning captures long-range dependencies between words, graphs elements and hence the model understands the context. Also, LLM generates text based on previously generated tokens.

In a related aspect, for training the LLM, output of the context vector is fed into a feed-forward neural network, which performs a non-linear transformation to generate a new representation. To stabilize the training process, the output from each layer is normalized, and a residual connection is added to allow the input to be passed directly to the output, allowing the model to learn which parts of the input are most important.

Referring to FIG. 6A, a neural network 600A of the data processing system in provided in accordance with an example embodiment of the invention. The neural network 1000 are trained using self-supervised, semi-supervised or unsupervised learnings. This enables the Master controller LLM agent to identify the intent even from the unknown elements of the data objects in the input.

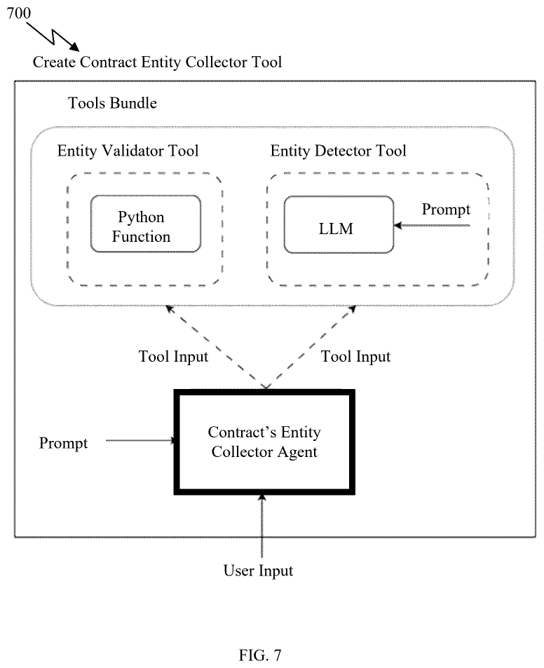

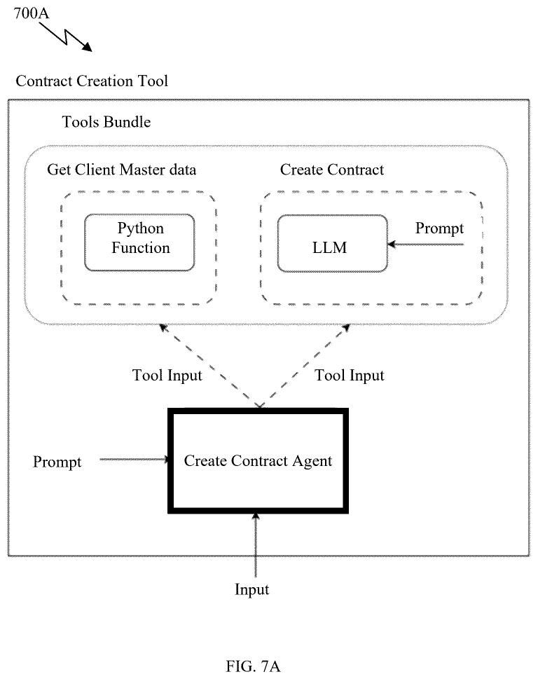

Referring to FIG. 7 and FIG. 7A flow diagram (700, 700A) depicting creation of a contract entity collector tool and a contract creation tool as a supply chain management task is provided in accordance with an example embodiment of the invention. The user inputs the query for creating a contract as: “I want to create a contract”. The query is routed to the Tool selection Agent which tries to identify the intent, select a list of tools from the tools repository to fulfill the user intent and chains the tool in order of execution. The selection action is Tools selected—Create Contract Entity Collector Tool, Contract Creator Tool, Email Generator Tool (FIG. 7A). The chaining action is Tool Chain—Create Contract Entity Collector Tool—Contract Creator—Email Generator. The tool selection agent is an instruction fine-tuned Large Language Model finetuned on the task of selecting and chaining right set of tools that can help fulfil user intent. The selected tools and the chain are passed to the Tool execution agent to execute the chain. The execution agent calls the first tool i.e. Create contract entity collector tool, passes the input and collects the response back. The execution agent checks the status of the tool execution and decides if the response is to be shown to the user. If yes, the response is sent back to the user. If the tool status indicates successful execution of the tool, then the execution agent calls the next tool in the sequence. This process repeats until all the tools are executed. Once all the tools are executed, the final output is again shown back to the user.

In an embodiment, the tool selection Agent is a finetuned Large Language model, finetuned using interface library-based framework to breakdown the user query into simple tasks and identify tools that can support the execution of those tasks.

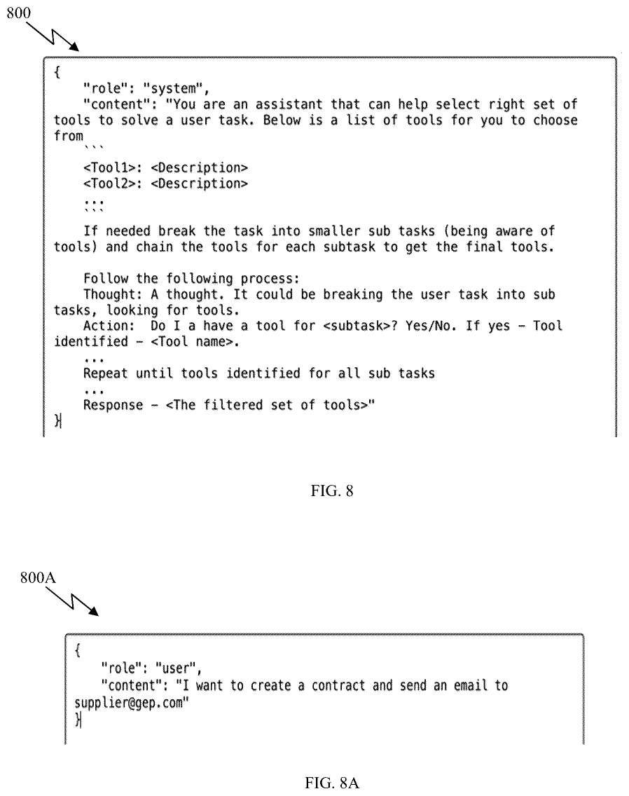

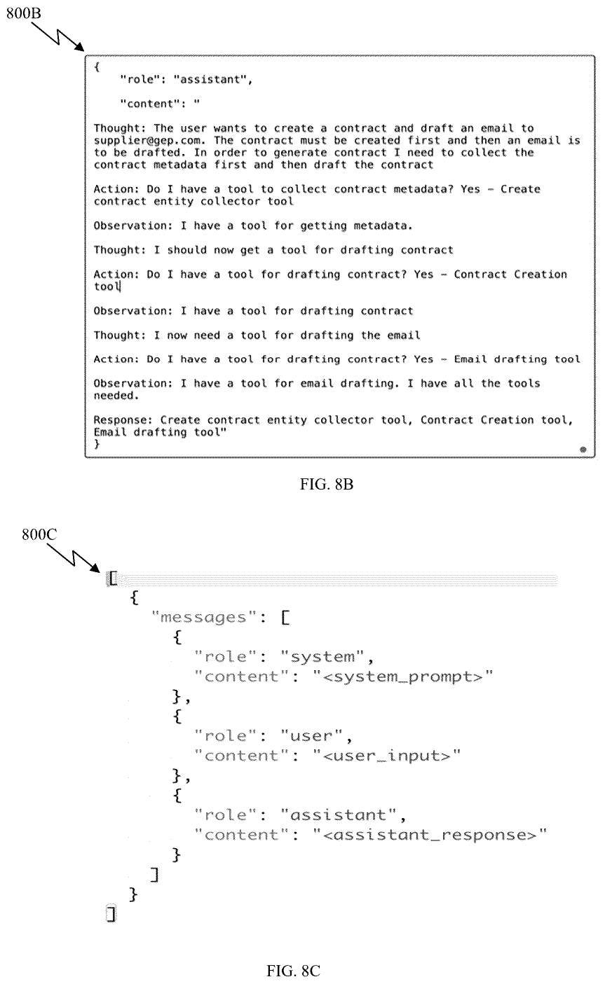

Referring to FIG. 8, a system prompt input 800 of the data processing system is provided in accordance with an example embodiment of the invention. The system prompt input defines the role of the LLM agent. The LLM agents understand the list of tools in the repository and their corresponding descriptions containing details about where they can be used.

Referring to FIG. 8A, a sample user input 800A with a natural language command of the data processing system is provided in accordance with an example embodiment of the invention.

Referring to FIG. 8B, a response screen 800B of the data processing system to the user input is provided in accordance with an embodiment of the invention. The screen 800B shows a response expected from the chatbot assistant.

Referring to FIG. 8C, a training data format screen 800C of the data processing system is provided in accordance with an example embodiment of the invention. The training data is an array of system message, user input and assistant object pairs.

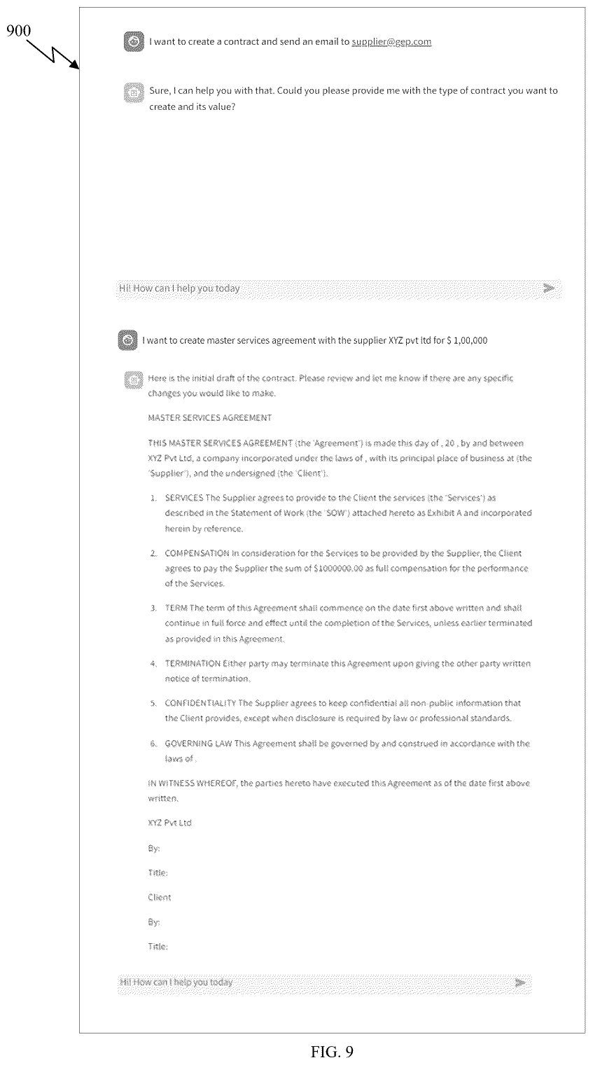

FIG. 9 shows an electronic user interface screen 900 of the data processing system having a chatbot for conversation orchestration to execute contract creation task in accordance with an example embodiment of the invention. The interface 900 shows a conversational chatbot enabling a user to create a contract. The chatbot with domain specific back end LLM agents executes the task identified from the text received as input at the interface screen. In this example embodiment, the LLM generates multiple clauses of a contract for a user. Further, in case of supply chain domain, there are multiple scenarios to be considered with multiple sub applications that impact the content of a contract. For eg: Purchase Order, Invoice amount, transportation details, warehouse management etc. Since, the data processing system of the present invention includes a Master Controller LLM agent interacting with multiple micro LLM agents trained on sub applications associated with the one or more supply chain application developed by a codeless platform, the learnings of the Micro-Controller LLM enables execution of specific tasks as well. In case the input received is specific about creating a contract with XYZ supplier for purchase of laptops for an amount $10000 based on the earlier contracts, the Master Controller LLM agent will be able to interact with micro LLM agents to fetch out the clauses based on the learning of each of the one or more micro LLM agents and tie it to the intent of the user received through the interface.

In an exemplary embodiment, the electronic user interface enables cognitive computing to improve interaction between user and the LLM based data processing system. The interface improves the ability of a user to use the computer machine itself. Since, the interface triggers conversational response it enables a user to interact with the chatbot seamlessly to execute the task. By eliminating unwanted domain specific interface elements, repetitive processing and recordation of information to get the desired data, which would be slow and complex the user interface is more user friendly and improves the functioning of the existing computer systems.

Further, in an exemplary embodiment, the codeless platform structuring applications with a low code framework enables developers to create applications by chaining multiple, micro LLM agents trained and perfected to carry out specific tasks. The present invention creates a set of micro-agents/micro LLM agent each specializing in a specific task. These micro LLM agents are configured to be seamlessly bound together via chains (in a deterministic flow setting) or can work under/assist a Master Agent as workers, with the master responsible for orchestrating the micro agents and executing a task (in non-deterministic flow setting). These micro LLM agents are extensible, customizable and have the ability to carry out natural language conversations if required.

In an exemplary embodiment, the large language model (LLM) in the micro LLM agent can be a standard LLM or a fine-tuned LLM for that specific task. The LLM of the Master controller LLM agent is specialized for full task planning to break down the applications into units of work and then also execute them.

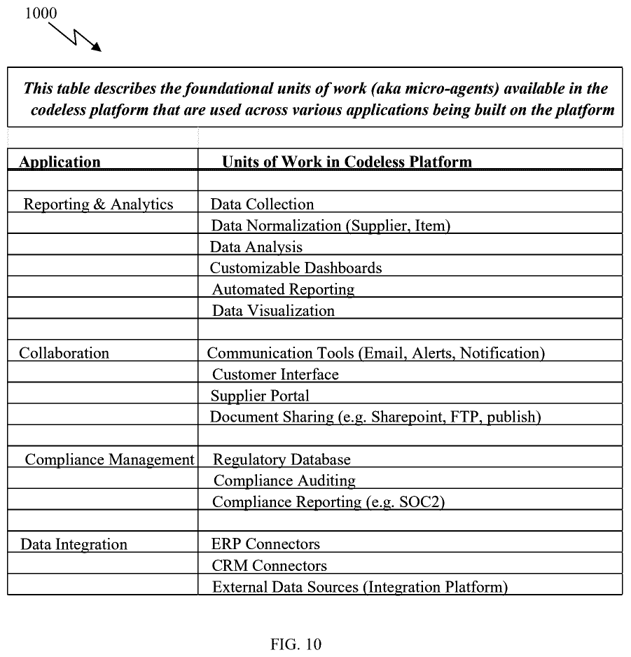

FIG. 10 shows a table of foundational units of work (micro LLM agents) available in the codeless platform that are used across various applications being built on the platform in accordance with an embodiment of the invention. For reporting and analysis application, data collection, data normalization, data analysis, customizable dashboards automated reporting and data visualization are all unit of works that enable creation and execution of tasks through application developed by the codeless platform. Further, for collaboration application the unit of work includes Communication Tools (Email, Alerts, Notification), Customer Interface, Supplier Portal, and Document Sharing (e.g. Sharepoint, FTP, publish). For compliance management, the unit of work may include a regulatory database, compliance auditing, Compliance Reporting (e.g. SOC2). For Data integration, the unit of work includes ERP Connectors, CRM Connectors and External Data Sources (Integration Platform).

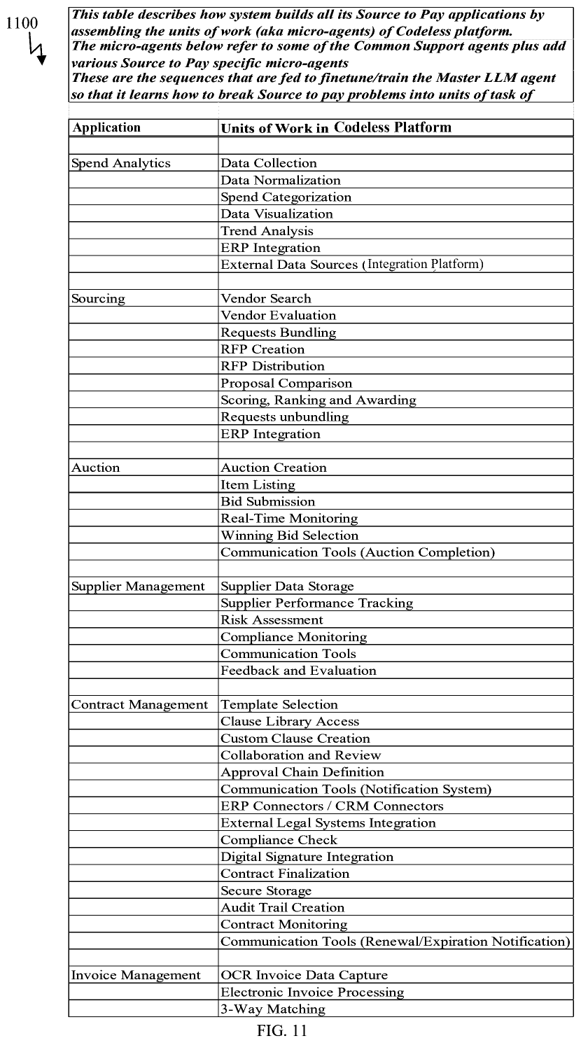

FIG. 11 shows a table of how the data processing system creates a Source to Pay application by assembling units of work of Codeless platform in accordance with an example embodiment of the invention. Some of the units of work is an application itself like spend analysis which shows the recursive characteristic of the unit of works highlighting the complexity in the data processing and the extent of accuracy required for predicting the intent and processing the task. For spend analytics application, the unit of works may include Data Collection, data Normalization, Spend Categorization, data Visualization, Trend Analysis, ERP Integration, External Data Sources (Integration Platform). For Sourcing application, the unit of work includes Vendor Search, Vendor Evaluation, Requests Bundling, RFP Creation, RFP Distribution, Proposal Comparison, Scoring, Ranking and Awarding, requests unbundling, ERP Integration. For Auction as an application the unit of work includes auction Creation, Item Listing, Bid Submission, Real-Time Monitoring, Winning Bid Selection and Communication Tools (Auction Completion). For Supplier Management application the unit of work includes Supplier Data Storage, Supplier Performance Tracking, Risk Assessment, Compliance Monitoring, Communication Tools feedback and evaluation. For contract management application, the unit of work includes template Selection, Clause Library Access, Custom Clause Creation, Collaboration and Review, approval Chain Definition, Communication Tools (Notification System), ERP Connectors/CRM Connectors, external Legal Systems Integration, Compliance Check, Digital Signature Integration, Contract Finalization, Secure Storage, Audit Trail Creation, Contract Monitoring and Communication Tools (Renewal/Expiration Notification). For invoice management application, the unit of work includes OCR Invoice Data Capture, electronic Invoice Processing, 3-Way Matching, Discrepancy Resolution, approval Workflow, payment Scheduling, Spend Analysis, Cash Flow Forecasting. For accounts payable, the unit of work includes payment processing, payment status tracking, account reconciliation, statement audit, financial Reporting, Compliance Reporting, Vendor Query Handling, Vendor Performance Analysis. For guided procurement application, the unit of work includes request Intake and Categorization, automated Guided Buying, preferred Supplier Listing, Order Placement Automation, policy Enforcement, Compliance Checks, Procurement Analytics.

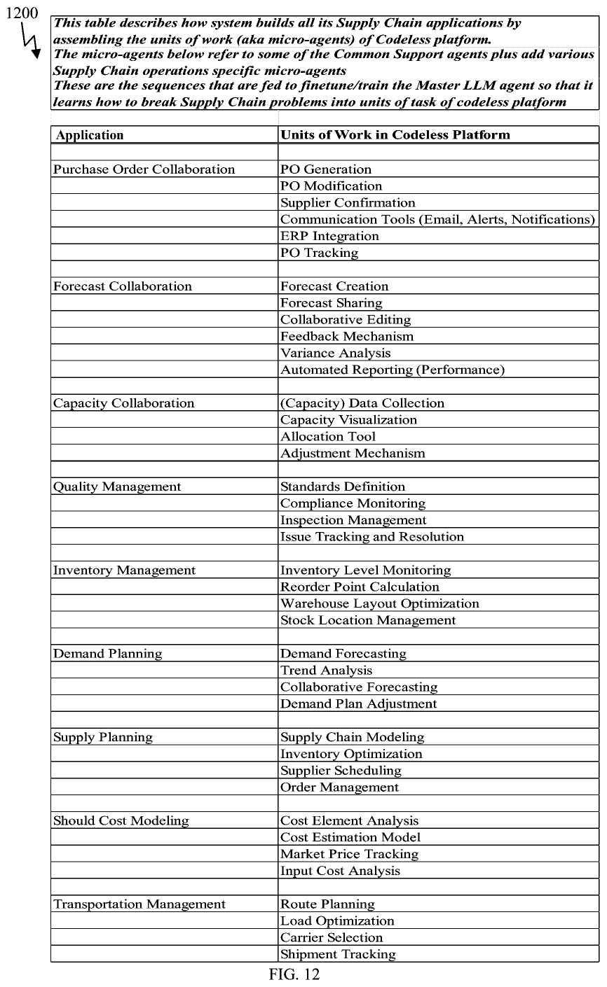

Referring to FIG. 12, a table 1200 showing how the data processing system creates a Supply Chain application by assembling the units of work of Codeless platform is provided in accordance with an example embodiment of the invention. For purchase order (PO), Collaboration application, the units of work include PO Generation, PO Modification, Supplier Confirmation, Communication Tools (Email, Alerts, Notifications), ERP Integration, PO Tracking. For Forecast Collaboration as application, the unit of work includes forecast Creation, Forecast Sharing, Collaborative Editing, Feedback Mechanism, Variance Analysis, Automated Reporting (Performance). For Capacity Collaboration as application, the unit of work includes (Capacity) Data Collection, Capacity Visualization, allocation Tool, adjustment mechanism. For Quality Management as application, the unit of work includes standards definition, Compliance Monitoring, Inspection Management, Issue Tracking and Resolution. For inventory management application, the unit of work includes inventory level monitoring, reorder point calculation, warehouse Layout Optimization, Stock Location Management. For demand planning application, the unit of work includes demand forecasting, trend analysis, collaborative forecasting, demand Plan Adjustment. For supply planning application, the unit of work includes Supply Chain Modeling, inventory optimization, supplier scheduling, order management. For should Cost Modeling application, the unit of work includes Cost Element Analysis, Cost Estimation Model, Market Price Tracking, input Cost Analysis. For transportation management application, the unit of work includes route planning, Load Optimization, carrier Selection, and Shipment Tracking.

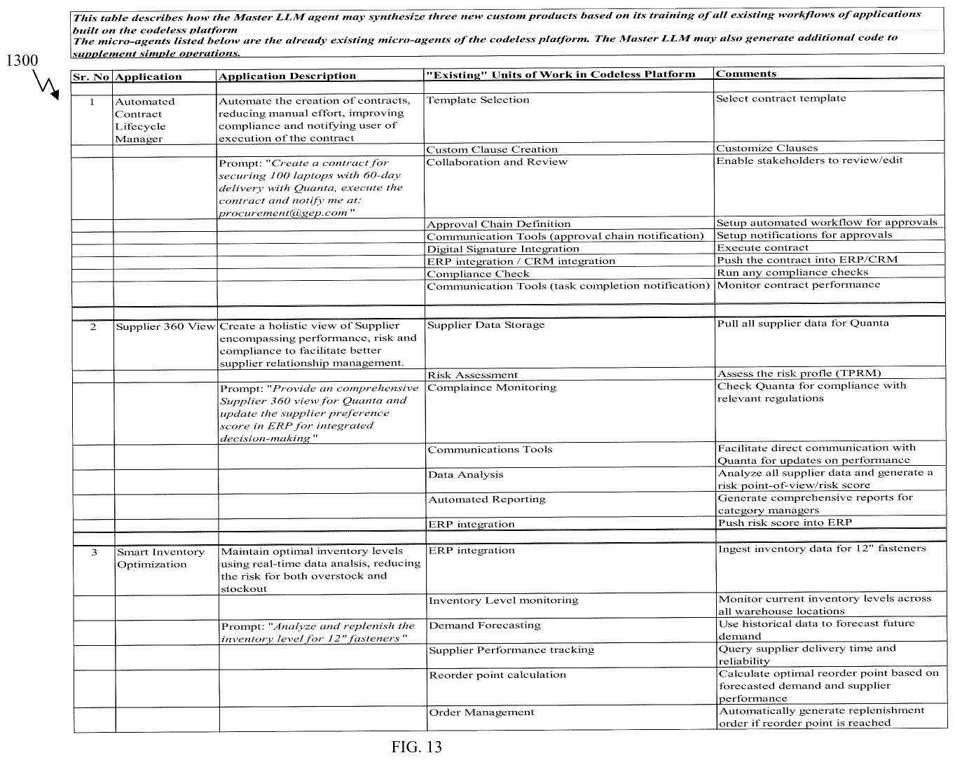

FIG. 13 shows a table 1300 of how a Master Controller LLM agent synthesizes three new custom applications based on its training of all existing workflows of the one or more applications created on the codeless platform in accordance with an example embodiment of the invention. The custom application includes automated contract lifecycle manager, supplier 360 view and Smart inventory optimization. The master controller LLM may generate additional code for supplementing simple operations.

In an exemplary embodiment, the present invention may be a system, a method, and/or a computer program product. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer system/computing device or as a separate product.

The computer readable storage medium can retain and store instructions for use by an instruction execution device i.e. it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

1. A data processing method comprising:
receiving at least one input from a user on an electronic user interface;
identifying one or more data objects from the received input to trigger a master controller LLM (large language model) agent for executing at least one task wherein the one or more data objects are associated with one or more application developed by a codeless platform; and
triggering through a processor, one or more micro LLM agent by the master Controller LLM agent for:
selecting a tool from a tool repository by a tool selector agent wherein the tool repository includes one or more tools configured to execute the at least one task; and
invoking the selected tool by a tool execution agent wherein the tool execution agent is configured to update the tool repository and act as a process orchestrator for executing the task.

2. The method of claim 1, wherein each of the one or more micro LLM agent is trained on a historical dataset associated with at least one application of the one or more application developed by the codeless platform.

3. The method of claim 2, wherein the at least one application includes a supply chain management application and the at least one task includes a supply chain management application task such as contract management, Purchase order, invoice management, Spend analysis, Sourcing, inventory management, demand planning, quality management, supply planning, should cost modeling, transportation management, warehouse management, forecasting, vendor management, risk assessment management and project management.

4. The method of claim 1, wherein the tool selector agent is a micro LLM agent configured to select and chain tools that can execute the at least one task.

5. The method of claim 1, wherein the process orchestrator performs sequence management, execution state control and conversation state management.

6. The method of claim 1, wherein the master controller LLM agent is configured to adapt to real time changing characteristics of the one or more application developed by the codeless platform and interact with the one or more micro LLM agents to execute the at least one task.

7. The method of claim 2, wherein the one or more micro LLM agent and the master controller LLM agent is trained by:
collecting, storing and pre-processing a plurality of historical data as a training data wherein the historical data is stored in a SCM historical database;
cleansing the training dataset by converting the historical data, removing unwanted text from the historical data and tokenizing the training dataset into sequences of tokens that form the training dataset; and
configuring a neural network based on the training dataset wherein the micro LLM agent is trained with supervised and unsupervised learning by presenting a sequence of text to the LLM agent for training the agent to predict next text in the sequence wherein the LLM agent adjusts its weight based on a difference between its prediction and actual text.

8. The method of claim 1, wherein the one or more micro LLM agent and the Master controller LLM agent are finetuned by:
loading a plurality of historical dataset related to one or more application workflows of the codeless platform into a vector index to enable semantic search;
triggering one or more unit of task action descriptions index and a knowledge graph on units of task as additional tools for the one or more micro LLM agent and the master controller LLM agent;
generating variations of the input requiring cross-referencing the unit of task action descriptions and knowledge graph including substituting steps within the workflow or augmenting the input with additional flows;
running the input including the variations through a reference LLM;
identifying one or more high reward input-output pair for fine tuning master controller LLM and one or more micro LLM agent; and
evaluating on a testing dataset, contextualization and substitution ability of the one or more LLM agents through the description index wherein a matrix is utilized on the testing dataset to assess the one or more LLM agents.

9. The method of claim 7, wherein the micro LLM agent is configured to be trained in a distributed structure with artificial intelligence controllers wherein different parts of the micro LLM agent are distributed across a plurality of Graphics processing units (GPU) for parallel training of the micro LLM agent.

10. The method of claim 9, wherein the parallel training of the micro LLM agent includes data parallelism, sequence parallelism, pipeline parallelism and tensor parallelism.

11. The method of claim 7, further comprises the step of evaluating performance of the one or more micro LLM agent based on a testing dataset wherein the one or more micro LLM agent is finetuned by adjusting one or more hyperparameters, chaining model architecture or training the micro LLM agent on additional training dataset to improve performance.

12. The method of claim 1, wherein the one or more application includes one or more supply chain management (SCM) application wherein the codeless platform develops the one or more SCM application by:
receiving at least one operation at a server for execution;
invoking a customization layer configured to customize the one or more Supply Chain Management (SCM) application based on the at least one operation to be executed;
organizing at least one application service of the one or more Supply Chain Management (SCM) application by an application layer wherein the application layer interacts with the customization layer through a plurality of configurable components;
fetching shared data objects by a shared framework layer for enabling execution of the at least one application service wherein the shared framework layer communicates with the application layer through the plurality of configurable components;
developing infrastructure by a foundation layer through the plurality of configurable components wherein the foundation layer communicates with the shared framework layer to enable fetching of shared data objects;
managing database native queries mapped to the at least one operation by a data layer wherein the data layer communicates with the foundation layer through the plurality of configurable components; and
developing the one or more Supply Chain Management (SCM) application by the plurality of configurable components interacting through an application orchestrator for executing the at least one operation.

13. The method of claim 12, wherein the master controller LLM agent is trained on one or more workflows of the one or more SCM application developed by the codeless platform wherein the master controller LLM agent is configured to generate codes for supplementing operations executed by the one or more SCM application.

14. The method of claim 13, wherein the electronic user interface includes an input component configured to receive the input, wherein the input component is a chatbot configured to receive a text, image or voice input wherein the image or voice input is converted to text by one or more processors for enabling the master controller LLM agent to identify the intent of the user and the at least one task to be executed.

15. A System comprising:
one or more processors; and
one or more memory devices including instructions that are executable by the one or more processor for causing the processor to
receive at least one input from a user on the electronic user interface;
identify one or more data objects from the received input to trigger a master controller large language model (LLM) agent for executing at least one task wherein the one or more data objects are associated with one or more application developed by a codeless platform; and
trigger through the one or more processors, one or more micro LLM agent by the master Controller LLM agent to:
select a tool from a tool repository by a tool selector agent wherein the tool repository includes one or more tools configured to execute the at least one task; and
invoke the selected tool by a tool execution agent wherein the tool execution agent is configured to update the tool repository and act as a process orchestrator for executing the task.

16. The system of claim 15, wherein each of the one or more micro LLM agent is trained on a historical dataset associated with at least one application of the one or more application developed by the codeless platform.

17. The system of claim 16, wherein the at least one application includes a supply chain management application such as contract management, Purchase order, invoice management, Spend analysis, Sourcing, inventory management, demand planning, quality management, supply planning, should cost modeling, transportation management, warehouse management, forecasting, vendor management, risk assessment management and project management.

18. The system of claim 17, wherein the tool selection agent is a micro LLM configured to select and chain tools that can execute the at least one task.

19. The system of claim 16, wherein the process orchestrator performs sequence management, execution state control and conversation state management.

20. The system of claim 17, wherein the master controller LLM agent is configured to adapt to real time changing characteristics of the one or more application developed by the codeless platform and interact with the one or more micro LLM agent to execute the at least one task.

21. The system of claim 17, wherein the one or more application includes one or more supply chain management (SCM) application wherein the codeless platform includes:
a plurality of configurable components; a customization layer; an application layer; a shared framework layer; a foundation layer; a data layer; and a SCM application orchestrator;
wherein the at least one processor is configured to cause the plurality of configurable components to interact with each other in a layered architecture to:
customize the one or more Supply Chain Management (SCM) application based on at least one operation to be executed using the customization layer;
organize at least one application service of the one or more Supply Chain Management (SCM) application by causing the application layer to interact with the customization layer through one or more configurable components of the plurality of configurable components, wherein the application layer is configured to organize the at least one application service of the one or more Supply Chain Management (SCM) application;
fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components;
manage database native queries mapped to that at least one operation using a data layer to communicate with the foundation layer through one or more configurable components of the plurality of configurable components, wherein the data layer is configured to manage database native queries mapped to the at least one operation; and
execute the at least one operation and develop the one or more Supply Chain Management (SCM) application using the SCM application orchestrator to enable interaction of the plurality of configurable components in the layered architecture.

22. The system of claim 21, wherein the master controller LLM agent is trained on one or more workflows of the one or more SCM application developed by the codeless platform wherein the master controller LLM agent is configured to generate codes for supplementing operations executed by the one or more SCM application.

23. The system of claim 21, further comprises:
a data network configured for storing and processing of one or more supply chain application dataset of the one or more supply chain application developed by the codeless platform, wherein a data network server is configured to receive the one or more supply chain application dataset from at least one data source;
one or more data element nodes configured to create one or more sub-network through a graphical data structure wherein one or more data elements are extracted from the one or more supply chain application dataset for analysis to identify the one or more data elements to be ingested as one or more data element node of the data network;
one or more data connectors of the graphical data structure configured for connecting the one or more data element node to form the data network wherein the one or more data connectors include at least one identifier configured to identify the one or more data element node of the data network based on at least one relationship between one or more data attributes associated with the received input, the at least one data object and one or more supply chain application dataset; and
an AI engine coupled to the processor configured for processing the input including the one or more data objects based on ensemble of one or more micro LLM agent wherein the one or more data attribute of the one or more supply chain application dataset are linked and the identifier is assigned based on the at least one relationship to one or more processed data elements of the one or more supply chain application dataset associated with the data attribute before ingesting the data element in the data network as a data element node to create the data network.

24. The system of claim 23, further comprises one or more large graph models (LGM) configured to interact with the one or more Micro LLM agent and Master controller LLM agent based on alignment of representation basis of graphs and text through paired data enabling interaction through natural language, or by transforming graph structures to text representations including adjacent list, edge list and inserting into LLM agents as prompts, or by aligning behavior of one or more graph models with one or more graph task scripts.

25. The system of claim 15, further comprises:
at least one storage layer configured for storing information including memory objects, selected tools information, state of execution, and error messages thereby tracking the information and data objects generated during the process orchestration.

26. The system of claim 15, wherein the one or more processors includes a request processor configured for routing the input to tool selector agent and tool executor agents.

27. The system of claim 22, wherein the electronic user interface includes an input component configured to receive the input, wherein the input component is a chatbot configured to receive a text, image or voice input wherein the image or voice input is converted to text by one or more processors for enabling the master controller LLM agent to identify the intent of the user and the at least one task to be executed.

28. The system of claim 15, wherein the one or more micro LLM agent and the Master controller LLM agent are finetuned by:
loading a plurality of historical dataset related to one or more application workflows of the codeless platform into a vector index to enable semantic search;
triggering one or more unit of task action descriptions index and a knowledge graph on units of task as additional tools for the one or more micro LLM agent and the master controller LLM agent;
generating variations of the input requiring cross-referencing the unit of task action descriptions and knowledge graph including substituting steps within the workflow or augmenting the input with additional flows;
running the input including the variations through a reference LLM;
identifying one or more high reward input-output pair for fine tuning master controller LLM and one or more micro LLM agent; and
evaluating on a testing dataset, contextualization and substitution ability of the one or more agent through the description index wherein a matrix is utilized on the testing dataset to assess the agents ability.

29. The system of claim 28, wherein the micro LLM agent is configured to be trained in a distributed structure with artificial intelligence controllers wherein different parts of the micro LLM agent are distributed across a plurality of Graphics processing Units (GPU) for parallel training of the micro LLM agent.

30. The system of claim 29, wherein the parallel training of the micro LLM agent includes data parallelism, sequence parallelism, pipeline parallelism and tensor parallelism.

31. A computer program product comprising a non-transitory computer readable storage medium that causes a processor to:
receive at least one input from a user on the electronic user interface;
identify one or more data objects from the received input to trigger a master controller large language model (LLM) agent for executing at least one task wherein the one or more data objects are associated with one or more application developed by a codeless platform; and
trigger through the one or more processors, one or more micro LLM agent by the master Controller LLM agent to:
select a tool from a tool repository by a tool selector agent wherein the tool repository includes one or more tools configured to execute the at least one task; and
invoke the selected tool by a tool execution agent wherein the tool execution agent is configured to update the tool repository and act as a conversation orchestrator with the user for executing the task.

32. The non-transitory computer program product of claim 31, wherein the method is performed in a cloud or cloud-based computing environment.

33. A method comprising:
receiving at least one input from a user on the electronic user interface;
identifying one or more data objects from the received input to trigger a micro LLM (large language model) agent for executing at least one task wherein an intent of the user is determined based on the identified data objects by a bot configured to map the intent with the micro LLM agent;
selecting a tool from a tool repository by a tool selector agent wherein the tool repository includes one or more tools configured to execute the at least one task; and
invoking the selected tool by a tool execution agent wherein the tool execution agent is configured to update the tool repository and act as a process orchestrator for executing the task.

34. The method of claim 33, wherein the one or more application includes a supply chain management application and the at least one task includes a supply chain management application task such as contract management, Purchase order, invoice management, Spend analysis, Sourcing, inventory management, demand planning, quality management, supply planning, should cost modeling, transportation management, warehouse management, forecasting, vendor management, risk assessment management and project management.
